(19) United States
(12) Patent Application Publication
(10) Pub. No.: US 2008/0098811 A1
(43) Pub. Date: May 1, 2008

(54) Sensor case and method for attaching a sensor case to a shoe

(75) Inventor: Kyle Brandenburg, Plantation, FL (US)

Correspondence Address: LERNER GREENBERG STEMER LLP, P O BOX 2480, HOLLYWOOD, FL, 33022-2480, US

(73) Assignee: Marware, Inc.

(21) Appl. No.: 11/586,268

(22) Filed: Oct. 25, 2006

(51) Int. Cl. G01D 11/24

(52) U.S. Cl. 73/431

(57) ABSTRACT

A sensor case for attachment to laces of a shoe, includes a flexible body to be inserted between the laces and the shoe in an open condition and manipulated into a folded-over and closed condition surrounding and secured to the laces. The folded-over and closed condition defines an interior of the body. A pouch is integral with the body for receiving a sensor. A fastener secures the body in the folded-over and closed condition with the pouch in the interior of the body. A method for attaching a sensor to a shoe is also provided.

### BACKGROUND OF THE INVENTION

1. Field of the Invention

The invention relates to a sensor case for attaching a wireless sensor to a shoe. More specifically, the sensor case is intended to secure the motion-sensing component (sensor) of the Nike+ipod Sport Kit, to a running shoe. The invention also relates to a method for attaching a sensor case to a shoe.

2. Description of the Related Art

The firms Apple and Nike have recently cooperated to provide a Nike+shoe which accommodates an ipod sensor, and a remote receiver (receiver) that is mounted to a dock connector port of an ipod nano and communicates with the sensor. The Nike+shoe has a built-in pocket under the insole for receiving the ipod sensor. The sensor communicates wirelessly with an ipod nano portable digital media player, when the receiver is attached. The sensor has an accelerometer which measures activity and wirelessly transfers data to the receiver on the iPod nano. The receiver is connected to the dock connector which is located at the bottom of the iPod nano, next to a headphone jack.

Performance feedback, including speed, distance and calories burned is transmitted to iPod headphones and a summary appears on the ipod nano screen with information as to how far and how fast the user has run. The ipod nano may then be connected to a computer to save workout information automatically online. The sensor turns on automatically when a person starts to walk, measures the runner's footstep, similarly to an odometer in a car and wirelessly transmits data to the receiver.

However, in order to use the iPod sensor, one previously had to purchase the Nike+shoe. Each serious runner favors a particular brand and model of running shoes with regard to size, fit, style and construction and may not be willing to use only the Nike+shoe because of its ability to accommodate the ipod sensor.

### SUMMARY OF THE INVENTION

It is accordingly an object of the invention to provide a sensor case and a method for attaching a sensor case to a shoe, which overcome the hereinafore-mentioned disadvantages of the heretofore-known devices and methods of this general type and which permit a sensor to be used with any shoe.

With the foregoing and other objects in view there is provided, in accordance with the invention, a sensor case for attachment to laces of a shoe. The sensor case comprises a flexible body to be inserted between the laces and the shoe in an open condition and manipulated into a folded-over and closed condition surrounding and secured to the laces. The folded-over and closed condition defines an interior of the body. A pouch is integral with the body and configured for receiving a sensor. A fastener secures the body in the folded-over and closed condition with the pouch in the interior of the body. The pouch and therefore the sensor within the pouch, are protected from the elements, while being secured in place in a location which permits the sensor to measure activity and wirelessly transfer data to a receiver on the portable digital media player.

In accordance with another feature of the invention, the fastener is a hook-and-loop fastener having hooks and loops disposed on opposite sides and at opposite ends of the body. Such fasteners provide a particularly user-friendly closure of the body of the sensor case.

In accordance with a further feature of the invention, the pouch is disposed at one end of the body. Due to its location at one end of the body, the pouch and therefore the sensor therein are surrounded and cushioned by a large part of the body.

In accordance with an added feature of the invention, the pouch is formed in one piece with the body. This feature provides for a cost-effective and durable manufacture of the body.

In accordance with an additional feature of the invention, the body is formed of water-resistant material, such as synthetic rubber based on polychloroprene. Due to its location on the front of a shoe, the body is subjected to all weather conditions and therefore such a water-resistant material is of great importance.

In accordance with yet another feature of the invention, there are provided regions respectively accommodating the hooks and loops, and a pad disposed on an opposite side of the body from one of the regions for manually applying pressure to engage the hooks and loops. This configuration of the hook-and-loop fastener provides ease of insertion and closure by a user of the device.

With the objects of the invention in view, there is also provided a method for attaching a sensor to a shoe having laces. The method comprises providing a sensor case having a flexible body with an integral pouch configured for receiving the sensor. The body is inserted between the laces and the shoe in an open condition. The body is manipulated into a folded-over and closed condition surrounding and secured to the laces and defining an interior of the body containing the pouch. The body is secured with a fastener in the folded-over and closed condition with the pouch in the interior of the body.

Other features which are considered as characteristic for the invention are set forth in the appended claims.

Although the invention is illustrated and described herein as embodied in a sensor case and a method for attaching a sensor case to a shoe, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, top-plan view of a sensor case according to the invention in a closed condition;

FIG. 2 is a side-elevational view of the sensor case in the closed condition;

FIG. 3 is an end-elevational view of the sensor case in the closed condition;

FIG. 4 is a bottom-plan view of the sensor case in the closed condition;

FIG. 5 is a perspective view of the sensor case in the closed condition;

FIG. 6 is a bottom-plan view of the sensor case in an open condition;

FIG. 7 is a side-elevational view of the sensor case in the open condition;

FIG. 8 is a top-plan view of the sensor case in an open condition;

FIG. 9 is an end-elevational view of the sensor case in an open condition;

FIG. 10 is a fragmentary, enlarged, bottom-plan view of the sensor case in the open condition, with a sensor partly inserted therein;

FIG. 11 is a fragmentary, perspective view of the sensor case placed in a mostly open condition and inserted beneath laces of a shoe;

FIG. 12 is a view similar to FIG. 11, with the sensor case being closed over the laces; and

FIG. 13 is another view similar to FIGS. 11 and 12 of the sensor case in a fully closed condition over the laces.

### DESCRIPTION OF THE PREFERRED EMBODIMENTS

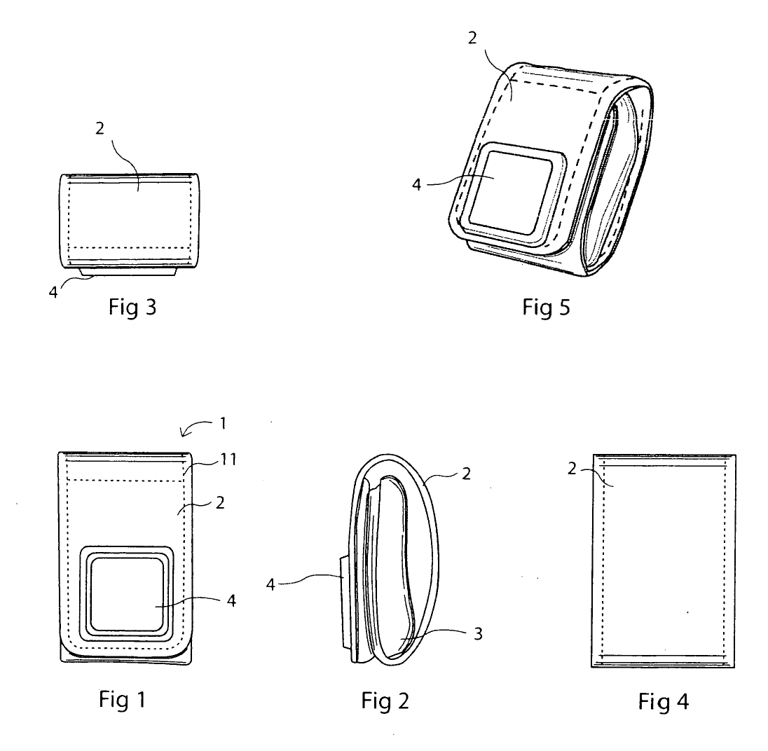

Referring now to the figures of the drawings in detail and first, particularly, to FIGS. 1-5 thereof, there is seen a sensor case or protective case 1 for accommodating a sensor, such as an iPod sensor for wirelessly communicating with a portable digital media player. The case 1 has a body 2 that is preferably made of synthetic rubber based on polychloroprene (a polymer form of Chloroprene), such as NEOPRENE, which is a trademark of DuPont Performance Elastomers. However, any material which is flexible, strong and protects the sensor from water, soiling and shocks, could be used.

It can be seen from FIG. 2 that a pouch 3 is disposed within the body 2 and configured for receiving the sensor. The pouch may be sewn to or formed in one piece with the body. The body 2 has stitching 11 and hook-and-loop fasteners 12, 13, such as VELCRO, a trademark of Velcro Industries B.V., which are not shown in FIGS. 1-5. The body 2 is folded over with the pouch 3 in the interior thereof, to reach the closed condition shown in FIGS. 1-5 and has a pad 4 for applying pressure to secure the hook-and-loop fasteners and maintain the closed condition. Of course, any other type of fastener, such one or more snaps, may also be used.

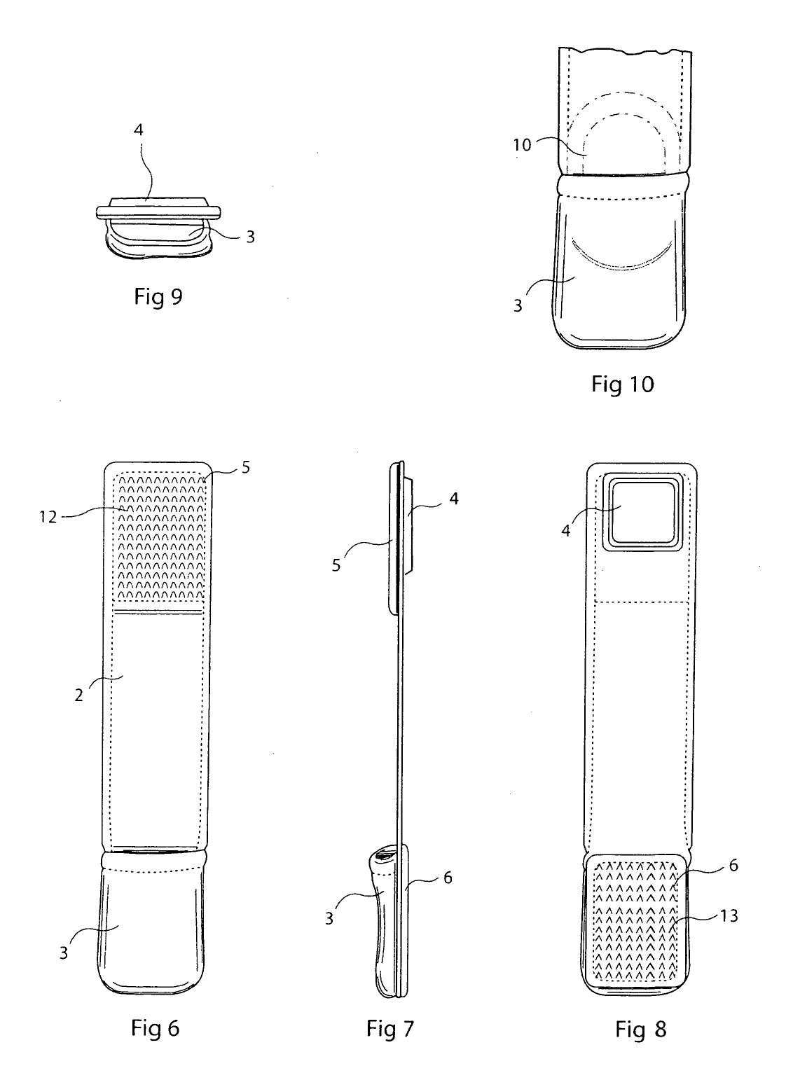

FIGS. 6-8 show the sensor case 1 in the open condition, from which it can be seen that either hooks or loops are placed on a region 5 on one side and at one end of the body 2, and either loops or hooks are placed on a region 6 on the other side and at the other end of the body 2. In FIGS. 6 and 8, hooks 12 are disposed on the region 5 and loops 13 are disposed on the region 6, but the opposite may be the case. The hooks and loops of the hook-and-loop fasteners will become engaged after the sensor case 1 is folded over and pressure is applied to the pad 4, in the closed condition shown in FIG. 9, so that the pouch 3 is disposed in the interior of the body 2. It can also be seen that the pouch 3 is disposed on the opposite side and at the opposite end from the pad 4, so that the pad 4 is in front of the region 5 and the region 6 is in front of the pouch 3.

FIG. 10 shows a sensor 10 being inserted downwardly into the pouch 3 of the body 2. The sensor 10 is inserted into the pouch 3 in an upside-down orientation, so that the sensor ends up in the proper orientation once the body is secured to the laces and folded-over. The sensor will not operate properly unless it is oriented right-side up in the case.

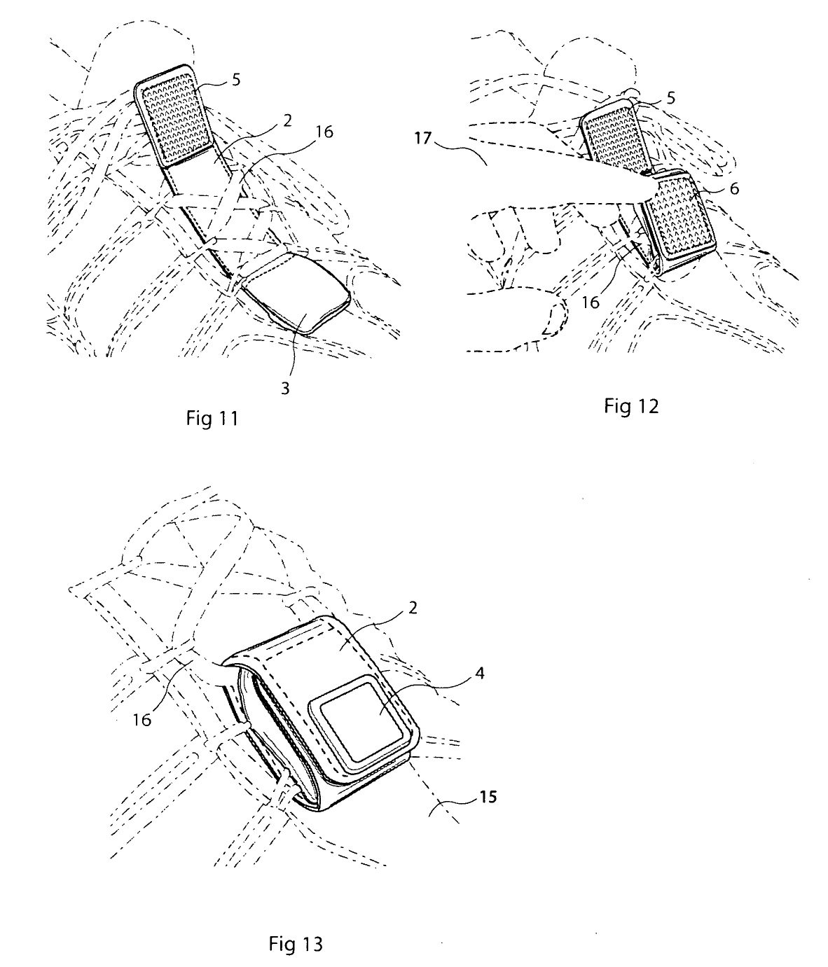

FIGS. 11-13 illustrate the method of securing the sensor case 1 to a shoe 15 having laces 16. It can be seen from FIG. 11, that the body 2 of the sensor case 1 with the sensor 10 in the pouch 3 is inserted behind several laces 16 of the shoe 15. The sensor may be placed in the pouch before or after inserting the body behind the laces. A finger 17 of a user then folds the body 2 over itself so that the regions 5, 6 having the hook-and-loop fasteners contact each other as shown in FIG. 12. Finally, pressure is applied to the pad 4 in the closed position seen in FIG. 13, so that the sensor case 1 is secured to the shoe 15 with the sensor 10 protected by several layers of rubber.

I claim:

1. A sensor case for attachment to laces of a shoe, the sensor case comprising:
a flexible body to be inserted between the laces and the shoe in an open condition and manipulated into a folded-over and closed condition surrounding and secured to the laces, said folded-over and closed condition defining an interior of said body;
a pouch integral with said body and configured for receiving a sensor; and
a fastener for securing said body in said folded-over and closed condition with said pouch in said interior of said body.

2. The sensor case according to claim 1, wherein said fastener is a hook-and-loop fastener having hooks and loops disposed on opposite sides and at opposite ends of said body.

3. The sensor case according to claim 1, wherein said pouch is disposed at one end of said body.

4. The sensor case according to claim 1, wherein said pouch is formed in one piece with said body.

5. The sensor case according to claim 1, wherein said body is formed of water-resistant material.

6. The sensor case according to claim 5, wherein said body is formed of synthetic rubber based on polychloroprene.

7. The sensor case according to claim 2, which further comprises regions respectively accommodating said hooks and loops, and a pad disposed on an opposite side of said body from one of said regions for manually applying pressure to engage said hooks and loops.

8. A method for attaching a sensor to a shoe having laces, the method comprising the following steps:
providing a sensor case having a flexible body with an integral pouch configured for receiving the sensor;
inserting the body between the laces and the shoe in an open condition;
manipulating the body into a folded-over and closed condition surrounding and secured to the laces and defining an interior of the body containing the pouch; and
securing the body with a fastener in the folded-over and closed condition with the pouch in the interior of the body.

9. The method according to claim 8, wherein the fastener is a hook-and-loop fastener having hooks and loops disposed on opposite sides and at opposite ends of the body.

10. The method according to claim 8, wherein the pouch is disposed at one end of the body.

11. The method according to claim 8, wherein the pouch is formed in one piece with the body.

12. The method according to claim 8, wherein the body is formed of water-resistant material.

13. The method according to claim 12, wherein the body is formed of synthetic rubber based on polychloroprene.

14. The method according to claim 8, wherein regions respectively accommodate the hooks and loops, and a pad is disposed on an opposite side of the body from one of the regions for manually applying pressure to engage the hooks and loops.
